(19) United States
(12) Patent Application Publication
(10) Pub. No.: US 2025/0183453 A1
(43) Pub. Date: Jun. 5, 2025

(54) ENERGY STORAGE APPARATUS

(71) Applicants: GS YUASA INTERNATIONAL LTD., Kyoto-shi, Kyoto (JP); TOYOTA JIDOSHA KABUSHIKI KAISHA, Toyota-shi, Aichi (JP)

(72) Inventors: Atsuyuki KONISHI, Kyoto-shi, Kyoto (JP); Yasuyuki IWASHIMA, Kyoto-shi, Kyoto (JP); Koki MAEDA, Kyoto-shi, Kyoto (JP); Takeyuki SHIRAISHI, Kyoto-shi, Kyoto (JP); Haruyuki ONODA, Toyota-shi, Aichi (JP)

(21) Appl. No.: 18/844,211

(22) PCT Filed: Mar. 1, 2023
(86) PCT No.: PCT/JP2023/007471

§ 371 Date: Sep. 5, 2024

(30) Foreign Application Priority Data
Mar. 17, 2022 (JP) 2022-042356

(51) Int. Cl. H01M 50/258; H01M 10/42; H01M 50/249; H01M 50/296

(52) U.S. Cl. CPC H01M 50/258; H01M 10/425; H01M 50/249; H01M 50/296; H01M 2010/4271

(57) ABSTRACT

An energy storage apparatus includes: an energy storage unit including an energy storage device and an outer case accommodating the energy storage device; and a control unit including a control device that is connected to a main current path of the energy storage device and controls the energy storage device. The control unit is removably attached to the outer case in a state of being in contact with the outer case.

### TECHNICAL FIELD

The present invention relates to an energy storage apparatus.

### BACKGROUND ART

There has been known an energy storage apparatus including an energy storage device and a control device that is connected to a main current path of the energy storage device and controls the energy storage device. PTL 1 discloses a device having a configuration in which a pair of input terminals of a control module are connected and fixed to a positive electrode tab and a negative electrode tab of a battery module accommodated in an exterior case, and a cover of the control module is mounted on the exterior case.

### CITATION LIST

### Patent Literature

### PTL 1

International Application Publication No. 2003/096446

### SUMMARY OF INVENTION

### Technical Problem

An energy storage apparatus including a control device that is connected to a main current path of an energy storage device to control the energy storage device like the conventional art described above has a risk that it would be difficult to perform maintenance, replacement, or the like for the control device. In such a conventional energy storage apparatus describe above, the control device is fixed to the energy storage device and a cover of the control device is provided to an outer case of the energy storage device, which makes it difficult to access the control device from the outside. Therefore, even if the control device has a program or the design of the control device is to be changed, it is difficult to perform maintenance, replacement, or the like for the control device.

The present invention is made by the inventors of the present application newly paying attention to the problems described above. An object of the present invention is to provide an energy storage apparatus that enables easily performing a maintenance operation, a replacement operation, or the like of a control device that is connected to a main current path of energy storage devices and controls the energy storage devices.

### Solution to Problem

In accordance with an aspect of the present invention, an energy storage apparatus includes: an energy storage unit including an energy storage device and an outer case accommodating the energy storage device; and a control unit including a control device that is connected to a main current path of the energy storage device and controls the energy storage device, wherein the control unit is removably attached to the outer case in a state of being in contact with the outer case.

The present invention may be implemented as not only an energy storage apparatus but also a combination of an outer case of an energy storage unit and a control unit.

### Advantageous Effects of Invention

The energy storage apparatus according to the present invention enables easily performing a maintenance operation, a replacement operation, or the like of a control device that is connected to a main current path of energy storage devices and controls the energy storage devices.

### BRIEF DESCRIPTION OF DRAWINGS

FIG. 1 is a perspective view illustrating an external appearance of an energy storage apparatus according to an embodiment.

FIG. 2 is a perspective view illustrating a configuration of the energy storage apparatus according to the embodiment, with an energy storage unit and a control unit being separated from each other.

FIG. 3 is an exploded perspective view illustrating constituent components included in the energy storage unit according to the embodiment in a disassembled manner.

FIG. 4 is an exploded perspective view illustrating the constituent components included in the energy storage unit according to the embodiment in a disassembled manner.

FIG. 5 is an exploded perspective view illustrating constituent components of an energy storage device according to the embodiment in a disassembled manner.

FIG. 6 is a perspective view and a front view illustrating a configuration of a part of the energy storage unit according to the embodiment to which the control unit is removably attached.

FIG. 7 is a perspective view and a rear view illustrating a configuration of the control unit according to the embodiment.

FIG. 8 is a perspective view illustrating a configuration of an energy storage apparatus according to a variation of the embodiment, with an energy storage unit and a control unit being separated from each other.

### DESCRIPTION OF EMBODIMENTS

(1) In accordance with an aspect of the present invention, an energy storage apparatus includes: an energy storage unit including an energy storage device and an outer case accommodating the energy storage device; and a control unit including a control device that is connected to a main current path of the energy storage device and controls the energy storage device, wherein the control unit is removably attached to the outer case in a state of being in contact with the outer case.

Accordingly, in the energy storage apparatus, the control unit includes the control device that is connected to the main current path of the energy storage devices and controls the energy storage devices, and is removably attached to the outer case included in the energy storage unit and accommodating the energy storage devices, in a state of being in contact with the outer case. As seen from the above, by configuring the control unit including the control device to be removably attached to the outer case of the energy storage unit, it is possible to attach and detach the control unit to and from the energy storage unit in a case where a malfunction occurs in the control device, a case where a design of the control device is to be changed, or the like. Thus, the control device can be attached to and detached from the energy storage unit, and thus it is possible to easily perform a maintenance operation, a replacement operation, or the like of the control device. Since the control unit is attached to the outer case of the energy storage unit in a state of being in contact with the outer case, it is possible to prevent an increase in size of the energy storage apparatus even when the control unit is configured to be removable.

(2) The energy storage apparatus according to the above (1) may further include: a connection member disposed on the main current path of the energy storage device, and removably connected to a connection part of the energy storage unit and a connection part of the control unit.

Accordingly, since the energy storage apparatus includes the connection member that is removably connected to the connection part of the energy storage unit and the connection part of the control unit, the control unit can be easily attached to and detached from the energy storage unit by attaching and detaching the connection member. Thus, it is possible to easily perform the maintenance operation, the replacement operation, or the like of the control device included in the control unit.

(3) The energy storage apparatus according to the above (1) or (2) may further include: a positive external terminal that is an external terminal of a positive electrode; and a negative external terminal that is an external terminal of a negative electrode, wherein at least one of the positive external terminal or the negative external terminal is provided to the control unit.

Accordingly, since at least one of the positive external terminal and the negative external terminal of the energy storage apparatus is disposed in the control unit, it is possible to dispose the external terminal close to the control device. Thus, it is possible to shorten a length of a conductive member coupling the external terminal and the control device together, such as a wire or a bus bar. By shortening the length of the conductive member, it is possible to reduce a resistance against the main current flowing, reduce a space to dispose the conductive member, and reduce costs. Since the external terminal can be attached to and detached from the energy storage unit together with the control unit, it is possible to easily perform a maintenance operation, a replacement operation, or the like of the external terminal.

(4) In the energy storage apparatus according to the above (3), it is possible that both of the positive external terminal and the negative external terminal are provided to the control unit.

Accordingly, since both of the positive external terminal and the negative external terminal of the energy storage apparatus are disposed in the control unit, it is possible to dispose both of the positive external terminal and the negative external terminal close to the control device. Thus, a component of the control device that is preferably disposed close to the positive external terminal can be disposed close to the positive external terminal, and a component of the control device that is preferably disposed close to the negative external terminal can be disposed close to the negative external terminal. Since both of the positive external terminal and the negative external terminal can be attached to and detached from the energy storage unit together with the control unit, it is possible to easily perform a maintenance operation, a replacement operation, or the like of both of the positive external terminal and the negative external terminal.

(5) In the energy storage apparatus according to any one of the above (1) to (4), it is possible that the outer case includes a guide part along which the control unit is slidable.

Accordingly, since the outer case of the energy storage unit includes the guide part along which the control unit is slidable, and the control unit can be slid to move with respect to the outer case, it is possible to easily attach and detach the control unit to and from the energy storage unit. Thus, it is possible to easily perform the maintenance operation, the replacement operation, or the like of the control device included in the control unit.

(6) In the energy storage apparatus according to the above (5), it is possible that the outer case further includes a regulating part that regulates movement of the control unit in a direction intersecting a sliding direction of the control unit.

Accordingly, since the outer case of the energy storage unit includes the regulating part, the movement of the control unit in the direction intersecting the sliding direction is regulated after the control unit is slid and attached to the energy storage unit. Thus, it is possible to easily prevent the control unit from coming off from the energy storage unit when the control unit is attached to the energy storage unit, and thus it is possible to easily perform an operation of attaching the control unit to the energy storage unit.

Hereinafter, a certain exemplary embodiment (including its variations) will be described in detail with reference to the accompanying Drawings. The following embodiment is a generic or specific example of the present invention. The numerical values, shapes, materials, elements, arrangement and connection configuration of the elements, steps, the order of the steps, etc., described in the following embodiment are merely examples, and are not intended to limit the present invention. Among elements in the following embodiment, those not described in any one of the independent claims indicating the broadest concept of the present invention are described as optional elements.

In the following description and the drawings, a longitudinal direction of the outer case of the energy storage apparatus, an arraying direction of a plurality of energy storage devices such as first energy storage devices and second energy storage devices, an arranging direction of the energy storage unit and the control unit, a sliding direction of the control unit with respect to the energy storage unit, an opposing direction of narrower lateral surfaces of a container of each of the energy storage devices, or an arranging direction of a pair of electrode terminals of one energy storage device is defined as an X-axis direction. An arranging direction of the energy storage devices and the bus bars or an arranging direction of a body and a lid of a container of each of the energy storage devices is defined as a Y-axis direction. An arranging direction of a body and a lid of the outer case, an arranging direction of the energy storage devices and restraining bodies, an arranging direction of the energy storage devices and spacers, an opposing direction of wider lateral surfaces of a container of each of the energy storage devices, a stacking direction of electrode sheets of an electrode body of each of the energy storage devices, or an up-down direction is defined as a Z-axis direction. These X-axis direction, Y-axis direction, and Z-axis direction are directions that intersect (perpendicularly in the present embodiment) one another. In some usage, it is possible that the Z-axis direction is not the up-down direction. However, the Z-axis direction will be described below as the up-down direction for convenience of description.

In the following description, a positive X-axis direction indicates an arrow direction of an X-axis, and a negative X-axis direction indicates an opposite direction to the positive X-axis direction. The same holds true for the Y-axis direction and the Z-axis direction. Hereinafter, the Z-axis direction may be also called a first direction, the Y-axis direction may be also called a second direction, and the X-axis direction may be also called a third direction. Expressions representing relative directions or attitudes, such as being parallel or perpendicular, include cases where the relative directions or attitudes are not strictly parallel or perpendicular to each other. Two directions being perpendicular to each other means not only the two directions being perfectly perpendicular to each other but also the two directions being substantially perpendicular to each other, that is, the two directions being perpendicular to each other with variations of about several percent.

### EMBODIMENT

### 1 General Description of Energy Storage Apparatus 1

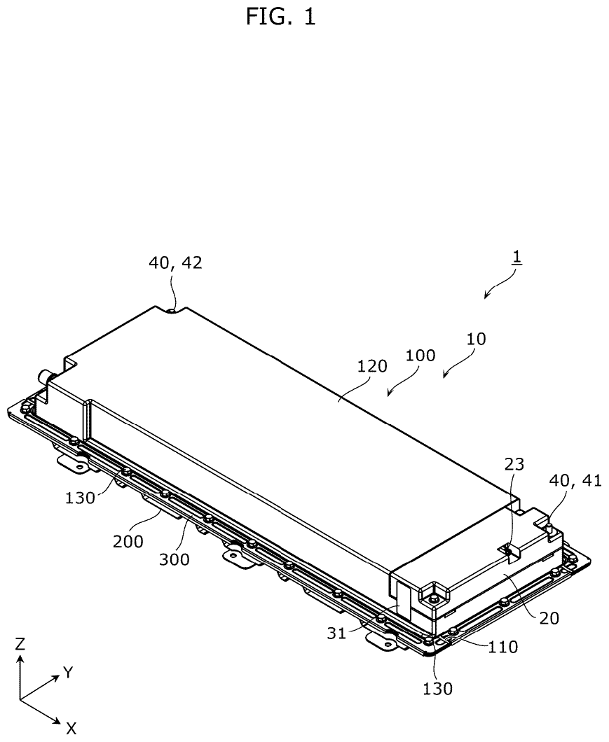

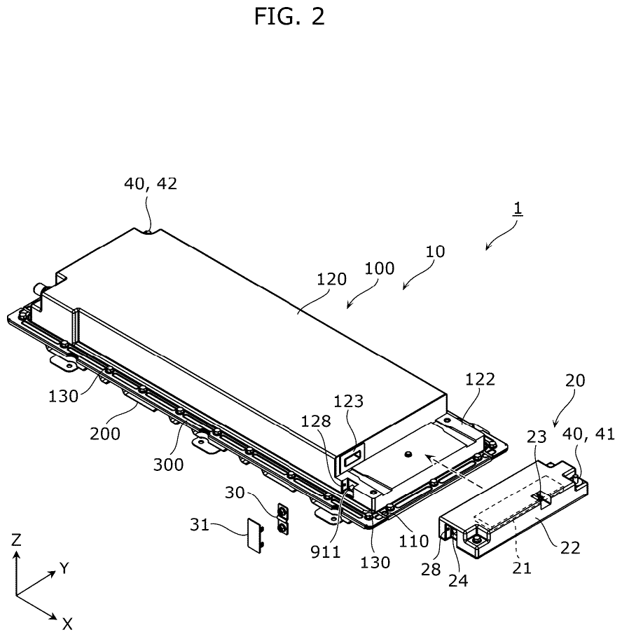

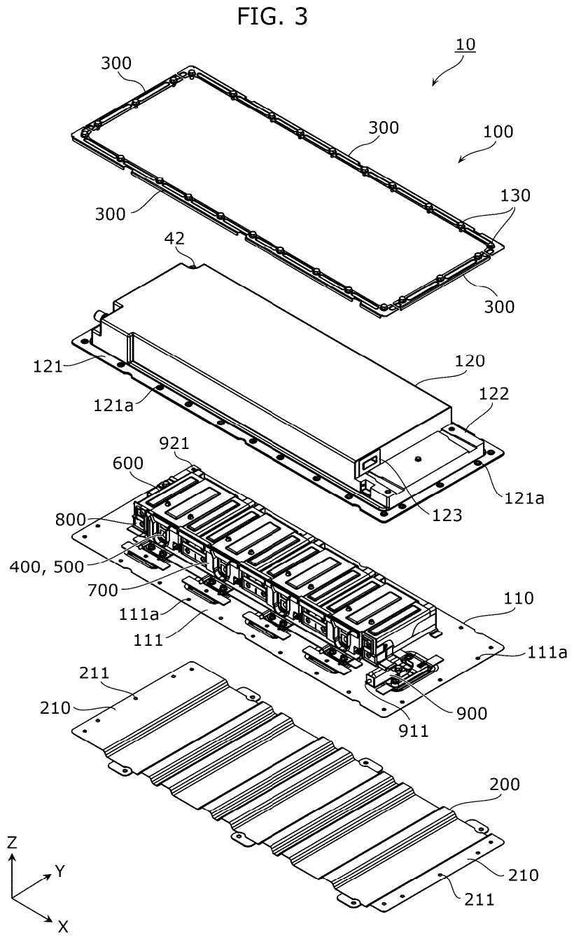

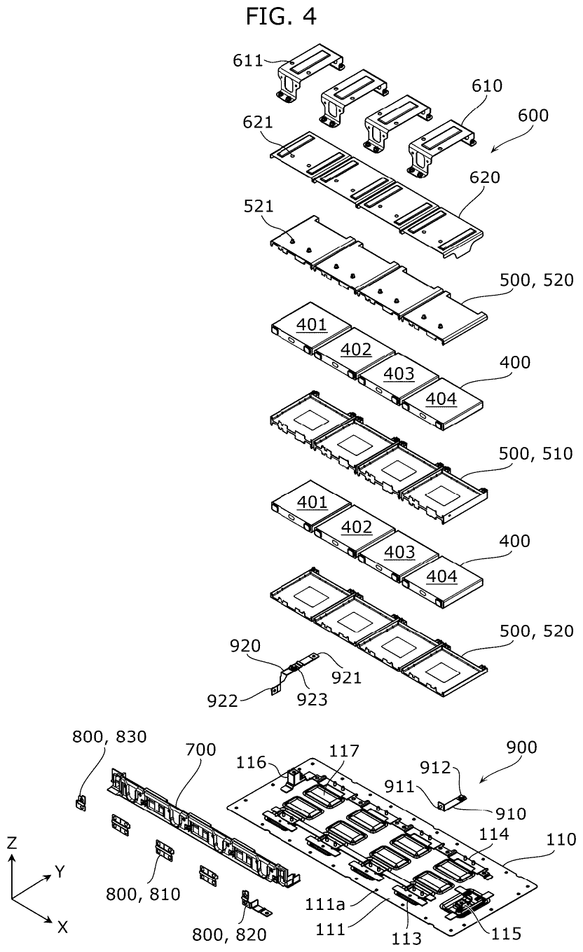

A schematic configuration of an energy storage apparatus 1 in the present embodiment will be first described. FIG. 1 is a perspective view illustrating an external appearance of the energy storage apparatus 1 according to the present embodiment. FIG. 2 is a perspective view illustrating a configuration of the energy storage apparatus 1 according to the present embodiment, with an energy storage unit 10 and a control unit 20 being separated from each other. FIG. 3 and FIG. 4 are exploded perspective views illustrating constituent components included in the energy storage unit 10 according to the present embodiment in a disassembled manner. FIG. 4 illustrates constituent components fixed to a first outer case 110 included in the energy storage unit 10 illustrated in FIG. 3 in a disassembled manner.

The energy storage apparatus 1 is a device that can be charged by external electricity from an outside and discharge electricity to the outside. In the present embodiment, the energy storage apparatus 1 has a substantially rectangular-parallelepiped shape. The energy storage apparatus 1 is a battery module (battery pack) used for an application such as electricity storage, power supply, or the like. Specifically, the energy storage apparatus 1 is used as a battery or the like for driving a mobile object such as an automobile, motorcycle, watercraft, vessel, snowmobile, agricultural machine, construction machine, or electric railway vehicle or for starting an engine thereof. Examples of the automobile include an electric vehicle (EV), a hybrid electric vehicle (HEV), a plug-in hybrid electric vehicle (PHEV), and a gasoline-powered automobile. Examples of the electric railway vehicle include an electric train, a monorail train, a linear motor train, and a hybrid railway vehicle that includes both of a diesel engine and an electric motor. The energy storage apparatus 1 can be also used as a stationary battery or the like for household use, an energy generator, or the like.

As illustrated in FIG. 1, FIG. 2, and the like, the energy storage apparatus 1 includes the energy storage unit 10, the control unit 20, a bus bar 30, a cover member 31, and a pair of (positive and negative) external terminals 40 (41 and 42). As illustrated in FIG. 3, FIG. 4, and the like, the energy storage unit 10 includes an outer case 100 and a first reinforcement member 200, and the outer case 100 accommodates, inside the outer case 100, energy storage devices 400, spacers 500, restraining bodies 600, a bus bar frame 700, bus bars 800, conductive members 900, and the like. As illustrated in FIG. 2 and the like, the control unit 20 includes a control device 21, an accommodating body 22, a connector 23, and a connection part 24. First, the constituent components included in the energy storage unit 10 will be described below in detail.

### 1.1 Description of Outer Case 100 and First Reinforcement Member 200

The outer case 100 is a container (module case) in a box shape (substantially rectangular-parallelepiped shape). The outer case 100 constitutes an outer case of the energy storage apparatus 1. The outer case 100 is disposed outside the energy storage devices 400 and the like, fixes the energy storage devices 400 and the like at their predetermined positions, and protects the energy storage devices 400 and the like from an impact and the like. The outer case 100 includes the first outer case 110, a second outer case 120, fixing members 130, and second reinforcement members 300.

The first outer case 110 is a member in a flat, rectangular shape. The first outer case 110 constitutes a body of the outer case 100, and the energy storage devices 400 and the like are mounted on and fixed to the first outer case 110. The second outer case 120 is a member in a bottomed, rectangular, tubular shape. The second outer case 120 constitutes a lid of the outer case 100, is disposed on a side of the first outer case 110 in a positive Z-axis direction, and is connected to the first outer case 110 to cover the energy storage devices 400 and the like. The second outer case 120 is formed with an opening on its negative Z-axis direction side, and the first outer case 110 is disposed in such a manner as to close the opening of the second outer case 120.

From a viewpoint of ensuring safety (crush resistance properties), the first outer case 110 is formed of a high-stiffness member such as a metal member, for example, stainless steel, aluminum, aluminum alloy, iron, or a steel sheet, or the metal member subjected to insulation treatment such as insulation coating. From a viewpoint of weight reduction and the like, the second outer case 120 is formed of a resin member (an insulating member) such as polycarbonate (PC), polypropylene (PP), polyethylene (PE), polystyrene (PS), polyphenylene sulfide resin (PPS), polyphenylene ether (PPE (including a modified PPE)), polyethylene terephthalate (PET), polybutylene terephthalate (PBT), polyether ether ketone (PEEK), tetrafluoroethylene-perfluoroalkyl vinyl ether (PFA), polytetrafluoroethylene (PTFE), polyether sulfone (PES), or ABS resin, or a composite material thereof. The first outer case 110 may be formed of the same resin member as the second outer case 120 but is preferably formed of a member having a high stiffness. The second outer case 120 may be formed of the same metal member as the first outer case 110.

The first outer case 110 includes a first connection part 111, attachment bases 113, 114, 115, and 116, and outer case protrusion parts 117. The second outer case 120 includes a second connection part 121 and a connector 123.

The first connection part 111 is a member (a flange part) in a rectangular shape with round corners in top view (as viewed in the Z-axis direction) that is disposed in an outer circumferential portion of the first outer case 110. The first connection part 111 is disposed at a position that is opposite to the second connection part 121 of the second outer case 120 and is connected to the second connection part 121 being placed on the second connection part 121. Likewise, the second connection part 121 is a member (a flange part) in a rectangular shape with round corners in top view that is disposed in an outer circumferential portion of the second outer case 120. The second connection part 121 is disposed at a position that is opposite to the first connection part 111, and is connected to the first connection part 111 being placed on the first connection part 111. The first connection part 111 and the second connection part 121 are connection parts that are connected to each other being placed one on the other in the Z-axis direction (the first direction), and are disposed extending in the Y-axis direction (the second direction intersecting the first direction) and the X-axis direction (the third direction intersecting the first direction and the second direction).

The attachment bases 113 and 114 are members to which the restraining bodies 600 are attached. Specifically, the attachment bases 113 are disposed at an end part of the first outer case 110 in a negative Y-axis direction. To the attachment bases 113, parts of first restraining bodies 610 described later of the restraining bodies 600 in the negative Y-axis direction are attached. The attachment bases 114 are disposed at an end part of the first outer case 110 in a positive Y-axis direction. To the attachment bases 114, parts of the first restraining bodies 610 in the positive Y-axis direction are attached. More specifically, the attachment bases 113 and 114 have bolt parts, and the restraining bodies 600 (the first restraining bodies 610) are attached to the attachment bases 113 and 114 by fastening the bolt parts with nuts.

The attachment bases 115 and 116 are members to which the conductive members 900 are attached. Specifically, the attachment base 115 is disposed at an end part of the first outer case 110 in the positive X-axis direction and the negative Y-axis direction. To the attachment base 115, an attachment part 912 described later of the conductive members 900 is attached. The attachment base 116 is disposed at an end part of the first outer case 110 in the negative X-axis direction and the positive Y-axis direction. To the attachment base 116, an attachment part 923 described later of the conductive members 900 is attached. More specifically, the attachment bases 115 and 116 have bolt parts, and the conductive members 900 (the attachment parts 912 and 923) are attached to the attachment bases 115 and 116 by fastening the bolt parts with nuts.

The outer case protrusion parts 117 are protrusion parts that project toward the energy storage devices 400. Specifically, the outer case protrusion parts 117 are protrusion parts (swell parts) in a swell shape and a rectangular shape in top view that project in the positive Z-axis direction. In the present embodiment, four pairs of two outer case protrusion parts 117 arranged in the Y-axis direction are disposed being arranged in the X-axis direction corresponding to four energy storage devices 400 that are arranged in the X-axis direction. The outer case protrusion parts 117 are disposed at positions that are opposite to wider lateral surfaces 411a described later of the energy storage devices 400. The outer case protrusion parts 117 press the wider lateral surfaces 411a of the energy storage devices 400.

The connector 123 is a connector to which a control wire (also referred to as a communication line, control line, communication cable, or control cable) that transmits information on voltages, temperatures, or the like of the energy storage devices 400 is connected. The connector 123 is disposed at an end part of the first outer case 110 in the positive X-axis direction and the negative Y-axis direction, being opposite to the control unit 20. Being connected to the control unit 20, the connector 123 transmits the information on voltages, temperatures, or the like of the energy storage devices 400 to the control unit 20. The connector 123 is electrically connected to the connector 23 of the control unit 20, and thus the information is transmitted to an outside.

The second reinforcement members 300 are members that are disposed at positions at which the second reinforcement members 300 and the first outer case 110 sandwich the second outer case 120 and extend along outer circumferential portions of the first outer case 110 and the second outer case 120. The second reinforcement members 300 are disposed at positions at which the second reinforcement members 300 and the first connection part 111 sandwich the second connection part 121, and each extend in the X-axis direction or the Y-axis direction (the third direction or the second direction). In the present embodiment, four second reinforcement members 300 are disposed along the substantially entire the outer circumferential portions of the first outer case 110 and the second outer case 120. In other words, the second reinforcement members 300 extend along a plurality of fixing members 130. The second reinforcement members 300 are formed of a high-stiffness member such as a metal member, for example, stainless steel, aluminum, aluminum alloy, iron, or a steel sheet, or the metal member subjected to insulation treatment such as insulation coating. Therefore, the second outer case 120 (the second connection part 121) has a stiffness lower than that of at least one (both in the present embodiment) of the first outer case 110 (the first connection part 111) and the second reinforcement members 300.

The fixing members 130 are members that connect (join) the first outer case 110 and the second outer case 120 together. Specifically, the plurality of fixing members 130 are disposed being arranged at substantially equal intervals on the first connection part 111 and the second connection part 121, and the first connection part 111 and the second connection part 121 are connected (joined) together with the second reinforcement members 300. In the present embodiment, the fixing members 130 are formed with bolts and nuts with which the bolts are to be fastened. The first connection part 111 is formed with through holes 111a, and the second connection part 121 and the second reinforcement members 300 are also formed with through holes (not illustrated). Through these through holes, the bolts of the fixing members 130 are inserted and fastened with the nuts. Thus, with the first connection part 111 and the second reinforcement members 300 sandwiching the second connection part 121, the fixing members 130 presses the second reinforcement members 300 toward the second connection part 121, thus connecting (fixing) the first connection part 111 and the second connection part 121 together. Another method of connecting (joining) the first outer case 110 and the second outer case 120 together may be employed, such as joining with rivets, joining by swaging, sandwiching with clips, bonding, welding, heat sealing, or ultrasonic welding.

The first reinforcement member 200 is a member in a plate shape that is arranged with the energy storage devices 400 in the Z-axis direction (the first direction) and is disposed along the outer case 100. The first reinforcement member 200 is attached to an outer surface of the outer case 100. Specifically, the first reinforcement member 200 is a member in a rectangular, corrugated shape that extends in the X-axis direction along the first outer case 110 on a side of the energy storage devices 400 and the first outer case 110 in the negative Z-axis direction. The first reinforcement member 200 is in contact with an outer surface of the first outer case 110 in the negative Z-axis direction and is attached to the outer surface. The first reinforcement member 200 may be formed by bending a plate-shaped member into a corrugated shape or may be formed by casting (die casting) or the like. In the present embodiment, the first reinforcement member 200 is attached to the first connection part 111 with the fixing members 130 at both end parts of the first reinforcement member 200 in the X-axis direction, together with the second connection part 121 and the second reinforcement members 300.

### 1.2 Description of Constituent Components in Outer Case 100

The energy storage devices 400 are secondary batteries (battery cells) that can be charged by electricity and discharge electricity. More specifically, the energy storage devices 400 are non-aqueous electrolyte secondary batteries such as lithium-ion secondary batteries. The energy storage devices 400 each have a flat, rectangular-parallelepiped shape (a square shape). In the present embodiment, eight energy storage devices 400 are arrayed in the Z-axis direction and the X-axis direction, being horizontally placed (falling sideways) (the wider lateral surfaces 411a described later of the energy storage devices 400 facing in the Z-axis direction). Specifically, two first energy storage devices 401 are stacked (stacked flat) in the Z-axis direction, two second energy storage devices 402 are stacked (stacked flat) in the Z-axis direction, two third energy storage devices 403 are stacked (stacked flat) in the Z-axis direction, and two fourth energy storage devices 404 are stacked (stacked flat) in the Z-axis direction. The two first energy storage devices 401, two second energy storage devices 402, two third energy storage devices 403, and two fourth energy storage devices 404 are arrayed being arranged in the X-axis direction from the negative X-axis direction to the positive X-axis direction.

The number of the energy storage devices 400 is not particularly limited. Any number of energy storage devices 400 may be disposed (stacked) in the Z-axis direction, and any number of energy storage devices 400 may be disposed (arrayed) in the X-axis direction. The shape of the energy storage devices 400 is not limited to the square shape and may be another shape, such as a polygonal-prism shape, columnar shape, cylindroid shape, or elliptic-cylinder shape. The energy storage devices 400 are not limited to non-aqueous electrolyte secondary batteries. The energy storage devices 400 may be secondary batteries other than non-aqueous electrolyte secondary batteries or may be capacitors. Rather than the secondary batteries, the energy storage devices 400 may be primary batteries, which can provide electricity stored therein without being charged by a user. The energy storage devices 400 may be batteries containing a solid electrolyte. The energy storage devices 400 may be pouch-type energy storage devices. A configuration of the energy storage devices 400 will be described later in detail.

The spacers 500 are spacers in a rectangular, tabular shape that are disposed adjacent to the energy storage devices 400. The spacers 500 are disposed on sides of the energy storage devices 400 in the positive Z-axis direction or the negative Z-axis direction, being opposite to wider lateral surfaces 411a of the energy storage devices 400. The spacers 500 are each formed of an insulating member made of any one of the resin materials or the like that can be used for the second outer case 120 or formed of a member having high heat-insulation properties such as a DAMMA material.

In the present embodiment, as the spacers 500, middle spacers 510 and pairs of end spacers 520 are disposed. The middle spacers 510 are spacers 500 that are each disposed between two energy storage devices 400, and the end spacers 520 are spacers 500 that are disposed between the energy storage devices 400 and the first outer case 110 or the restraining bodies 600. The middle spacers 510 and the pairs of end spacers 520 are disposed such that the middle spacers 510 and the pairs of end spacers 520 sandwich the energy storage devices 400 in the Z-axis direction, thus electrically insulating between the energy storage devices 400 and between the energy storage devices 400, and the first outer case 110 and the restraining bodies 600. In the present embodiment, since the first energy storage devices 401 to the fourth energy storage devices 404 are disposed being arranged in the X-axis direction, the middle spacers 510 and the pairs of end spacers 520 are disposed correspondingly to the first energy storage devices 401 to the fourth energy storage devices 404. Instead of or in addition to the spacers 500, insulation sheets may be disposed on lateral surfaces of the energy storage devices 400.

Each of the end spacers 520 disposed on a positive Z-axis direction side is formed with two projections 521 arranged in the X-axis direction at an end part of the end spacer 520 in the negative Y-axis direction. The projections 521 are projections in a columnar shape that project in the positive Z-axis direction and are inserted into through holes 611 in a circular shape formed in the first restraining bodies 610 of the restraining bodies 600 described later and into through holes 621 in a circular shape formed in second restraining bodies 620. Thus, it is possible to position the restraining bodies 600 with respect to the spacers 500 (and the energy storage devices 400).

The restraining bodies 600 are members that sandwich, with the first outer case 110, the plurality of energy storage devices 400 such as the first energy storage devices 401 and the second energy storage devices 402 in the Z-axis direction. Specifically, the first outer case 110 and the restraining bodies 600 are joined together to sandwich the plurality of energy storage devices 400. Thus, the first outer case 110 and the restraining bodies 600 restrain the plurality of energy storage devices 400 in the Z-axis direction (give a restraining force in the Z-axis direction to the plurality of energy storage devices 400). The first outer case 110 extends in the X-axis direction over the first energy storage device 401 to the fourth energy storage device 404, and the restraining bodies 600 individually restrain, with the first outer case 110, the first energy storage device 401 to the fourth energy storage device 404. The restraining bodies 600 are formed of the metal member or the like that can be used for the first outer case 110.

The restraining bodies 600 include the first restraining bodies 610 and the second restraining bodies 620. The first restraining bodies 610 are plate-shaped members in an inverted U shape as viewed from the X-axis direction that are disposed on sides of the second restraining bodies 620 in the positive Z-axis direction and are joined to the first outer case 110. The second restraining bodies 620 are plate-shaped members that are disposed on sides of the energy storage devices 400 and the spacers 500 (end spacers 520) in the positive Z-axis direction in such a manner as to cover the substantially entire lateral surfaces of the energy storage devices 400 and the spacers 500 (end spacers 520) in the positive Z-axis direction. The first restraining bodies 610 and the second restraining bodies 620 are formed with protrusion parts (swell parts) that extend in the Y-axis direction for improving strength and the like. Positions, a shape, and the number of the protrusion parts (swell parts) are not particularly limited. The first restraining bodies 610 and the second restraining bodies 620 need not be formed with the protrusion parts (swell parts). Each pair of a first restraining body 610 and a second restraining body 620 may be integrally formed. The restraining bodies 600 need not include the second restraining bodies 620.

The first energy storage devices 401 to the fourth energy storage devices 404 are disposed being separated from each other. The restraining bodies 600 arranged in the X-axis direction are also disposed being separated from each other. Thus, it is possible to prevent heat from being conducted between the first energy storage devices 401 and the second energy storage devices 402. Therefore, it is possible to prevent the first energy storage devices 401 and the second energy storage devices 402 from thermally affecting each other. In gaps between the first energy storage devices 401 and the second energy storage devices 402, insulator may be disposed. This makes it possible to further prevent the first energy storage devices 401 and the second energy storage devices 402 from thermally affecting each other.

The bus bar frame 700 is an insulating member in a flat, rectangular shape that can electrically insulate the bus bars 800 from other members and regulate positions of the bus bars 800. The bus bar frame 700 is formed of any one of the resin materials or the like that can be used for the second outer case 120. The bus bar frame 700 is disposed on a side of the plurality of energy storage devices 400 in the negative Y-axis direction. By the bus bar frame 700 being positioned with respect to the plurality of energy storage devices 400, the bus bars 800 are positioned with respect to the plurality of energy storage devices 400 and joined to electrode terminals included in the plurality of energy storage devices 400.

The bus bars 800 are members in a tabular shape that are disposed on sides of the plurality of energy storage devices 400 in the negative Y-axis direction and are connected (joined) to the plurality of energy storage devices 400 and the conductive members 900. The bus bars 800 include bus bars 810, 820, and 830. The bus bars 810 each connect electrode terminals 420 described later included in adjacent energy storage devices 400. The bus bars 820 and 830 connect corresponding electrode terminals 420 of energy storage devices 400 to the attachment part 912 and a connection part 922 described later of the conductive members 900, thus electrically connecting the energy storage devices 400 to the positive and negative external terminals 40 (41 and 42).

In the present embodiment, the bus bars 800 and the electrode terminals 420 of the energy storage devices 400 are connected (joined) together by welding. However, the bus bars 800 and the electrode terminals 420 may be connected (joined) by bolt securing or the like. The bus bars 800 are connected (joined) to the attachment part 912 and the connection part 922 of the conductive members 900 by bolt securing. However, the bus bars 800 may be connected (joined) to the attachment part 912 and the connection part 922 by welding or the like. The bus bars 800 are formed of a metallic conductive member made of aluminum, aluminum alloy, copper, copper alloy, nickel, or the like, or a combination thereof or formed of a non-metallic conductive member. In the present embodiment, the bus bars 800 connect every two of the energy storage devices 400 together in parallel to form four sets of energy storage devices 400 and connect the four sets of energy storage devices 400 together in series. However, the bus bars 800 may connect all of the eight energy storage devices 400 together in series or may connect the energy storage devices 400 in another configuration.

The conductive members 900 are conductive members that are connected to the bus bars 800 and the control unit 20 to electrically connect the energy storage devices 400 and the external terminals 40 (41 and 42). The conductive members 900 are conductive members that are disposed on a main current path (also referred to as a power supply line, power line, main circuit cable, power supply cable, or power cable) of the energy storage devices 400. The main current path of the energy storage devices 400 is a path of a main current of the energy storage devices 400, a current that flows through electrode assembly 460 described later included in the energy storage devices 400 (a charge-discharge current). In other words, the conductive members 900 are members that are disposed on a path between the energy storage devices 400 and the external terminals 40 (41 and 42) and through which the charge-discharge current flows when the energy storage apparatus 1 is charged or discharges. The conductive members 900 are formed of a metallic conductive member made of aluminum, aluminum alloy, copper, copper alloy, nickel, or the like, or a combination thereof or formed of a non-metallic conductive member.

The conductive members 900 include a conductive member 910 and a conductive member 920. The conductive member 910 includes a connection part 911 and the attachment part 912. The conductive member 920 includes connection parts 921 and 922, and the attachment part 923.

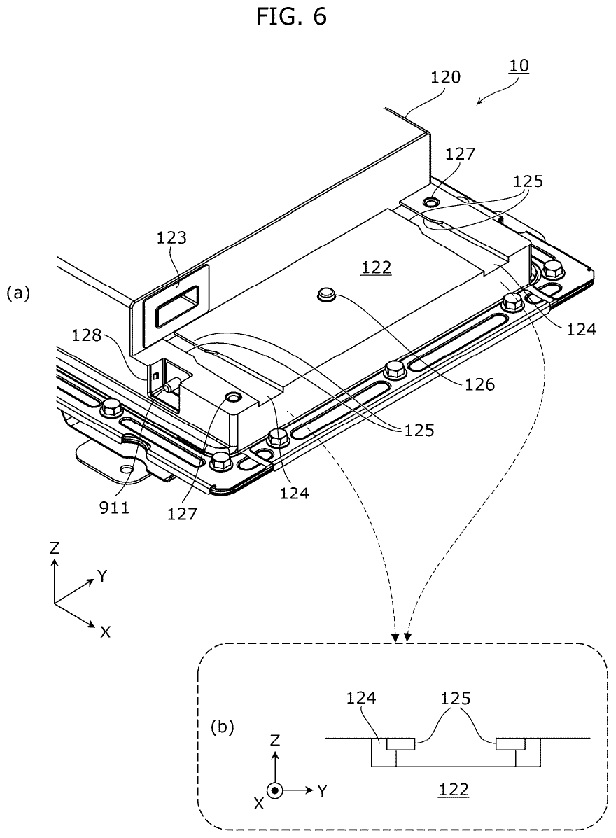

The connection part 911 is a part that is connected to the bus bar 30. The connection part 911 is disposed projecting from the second outer case 120 by subjecting the connection part 911 to, for example, insert molding in the second outer case 120. Specifically, the connection part 911 is disposed in such a manner as to penetrate the second outer case 120 in the negative Y-axis direction from an inside of the second outer case 120, projecting into a recess part 128 that is formed on a lateral surface of the second outer case 120 in the negative Y-axis direction (see FIG. 6). The connection part 911 is connected to the external terminal 41 via the bus bar 30 and the connection part 24. As mentioned above, the attachment part 912 is a part that is attached to the attachment base 115 and connected to the bus bar 820. In the present embodiment, the conductive member 910 has a configuration in which a plate-shaped member extends from the connection part 911 to the attachment part 912.

The connection part 921 is a part that is connected to the external terminal 42. The connection part 922 is a part that is connected to the bus bar 830. As mentioned above, the attachment part 923 is a part that is attached to the attachment base 116 of the first outer case 110. In the present embodiment, the conductive member 920 has a configuration in which a plate-shaped member extends from the connection part 921 via the attachment part 923 to the connection part 922.

### 1.3 Description of Control Unit 20 and Other Constituent Components

Next, the control unit 20 and other constituent components (the bus bar 30, the cover member 31, the pair of (positive and negative) external terminals 40 (41 and 42)) will be described in detail.

The control unit 20 is a device including the control device 21 that controls the energy storage devices 400 in the energy storage unit 10. Specifically, the control unit 20 is a battery management system (BMS) that controls the energy storage devices 400. The control device 21 is an instrument that is connected to the main current path of the energy storage devices 400 and controls the energy storage devices 400. The control device 21 includes a circuit board, a fuse, a relay, a semiconductor switch such as a field effect transistor (FET), a shunt resistance, and the like for controlling charging and discharging the energy storage devices 400. In FIG. 2, the control device 21 is illustrated with broken lines that surround a flat, rectangular-parallelepiped shape for convenience of illustration. However, the shape of the control device 21 is not particularly limited. The control device 21 is accommodated in the accommodating body 22. The accommodating body 22 is a container in a box shape (a substantially rectangular-parallelepiped shape). The accommodating body 22 is formed of any one of the electrically insulative resin materials or the like that can be used for the second outer case 120.

The control unit 20 is removably attached to the energy storage unit 10. Specifically, the control unit 20 is removably attached to the outer case 100 in a state of being in contact with the outer case 100 of the energy storage unit 10. Unlike such a configuration in which the control unit 20 is disposed being separated from the energy storage unit 10 and connected to the energy storage unit 10 with a cable or the like, the control unit 20 is connected to the energy storage unit 10 with the bus bar 30 in a state where the accommodating body 22 is in contact with the outer case 100. In the present embodiment, the control unit 20 is removably attached to an outer case end part 122 that is a recessed part at an end part of the second outer case 120 in the positive X-axis direction. The outer case end part 122 is a part that includes a surface at which the outer case 100 faces outward (a surface facing in the positive Z-axis direction). The control unit 20 is in contact with the surface of the outer case 100 of the energy storage unit 10 facing outward (the surface facing in the positive Z-axis direction). In the present embodiment, the control unit 20 is also in contact with a surface of the outer case 100 facing the positive X-axis direction (a surface of the outer case 100 facing outward). A configuration that enables the control unit 20 to be removably attached to the energy storage unit 10 will be described later in detail.

The connector 23 is a connector for control that is disposed at a corner part of the accommodating body 22 in the positive X-axis direction and the positive Z-axis direction and is connected to the connector 123 via an electric wire (a control line) or the like (not illustrated) in the control unit 20. At a position on a surface of the accommodating body 22 in the negative X-axis direction that is opposite to the connector 123, another connector (not illustrated) that is connected to the connector 23 via the electric wire (control line) or the like and can be attached to and detached from the connector 123 is disposed. By attaching the control unit 20 to the energy storage unit 10, the connector 123 and the other connector, and thus the connector 23 and the connector 123 are electrically connected together. As seen from the above, the energy storage unit 10 and the control unit 20 have a configuration in which both of the power supply line (main current path) and the control line (control current path) are removably connected.

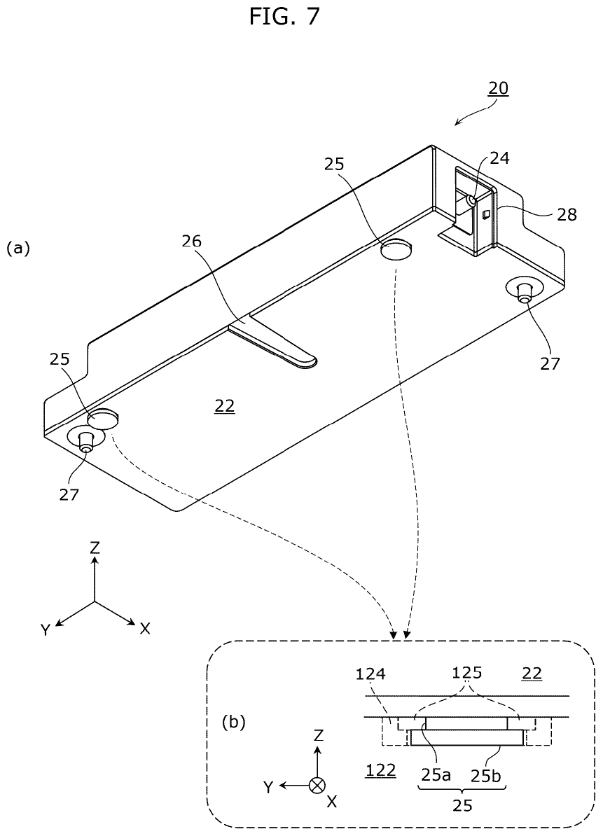

The connection part 24 is a part that is connected to the bus bar 30. The connection part 24 is disposed projecting from a lateral surface of the accommodating body 22 by subjecting the connection part 24 to, for example, insert molding on the lateral surface of the accommodating body 22. The connection part 24 is formed of a metallic conductive member made of aluminum, aluminum alloy, copper, copper alloy, or the like. Specifically, the connection part 24 is disposed in such a manner as to penetrate the accommodating body 22 in the negative Y-axis direction from an inside of the accommodating body 22, projecting into a recess part 28 that is formed on a lateral surface of the accommodating body 22 in the negative Y-axis direction (see FIG. 7). When the control unit 20 is attached to the energy storage unit 10, the connection part 24 is disposed on a side of the connection part 911 in the positive Z-axis direction, and by connecting the connection part 24 to the bus bar 30, the connection part 24 is connected to the connection part 911 via the bus bar 30.

The bus bar 30 is a member in a tabular, rectangular shape that extends in parallel to an XZ plane and in the Z-axis direction. The bus bar 30 is disposed on the main current path of the energy storage devices 400 to mechanically and electrically connect the energy storage unit 10 and the control unit 20 together. The bus bar 30 is formed of a metallic conductive member made of aluminum, aluminum alloy, copper, copper alloy, nickel, or the like, or a combination thereof or formed of a non-metallic conductive member.

The bus bar 30 is disposed inside the recess part 128 of the second outer case 120 and the recess part 28 of the accommodating body 22. By connecting (joining) the bus bar 30 to the connection part 911 and the connection part 24 by bolt securing, the bus bar 30 connects the energy storage unit 10 and the control unit 20 together. The bus bar 30 may be connected (joined) to the connection part 911 and the connection part 24 by removable means other than bolt securing, such as engaging or fitting. The bus bar 30 is an example of a connection member that is removably connected to the connection part 911 of the energy storage unit 10 and the connection part 24 of the control unit 20.

The cover member 31 is a member in a tabular, rectangular shape that is disposed at positions of the energy storage unit 10 and the control unit 20 corresponding to the bus bar 30. The cover member 31 is formed of any one of the resin materials or the like that can be used for the second outer case 120. The cover member 31 is disposed in such a manner as to close the recess parts 128 and 28 when the bus bar 30 is disposed inside the recess part 128 of the second outer case 120 and the recess part 28 of the accommodating body 22.

Of the external terminals 40, the external terminal 41 is a positive external terminal (a positive module terminal (a battery terminal)) being an external terminal of the positive electrode that is electrically connected to a positive electrode terminal of an energy storage device 400 included in the energy storage unit 10. The external terminal 41 is disposed at an end part of the control unit 20 in the positive X-axis direction and the positive Y-axis direction. Specifically, the external terminal 41 is disposed projecting in the positive Z-axis direction from a corner part of the accommodating body 22 in the positive X-axis direction and the positive Y-axis direction by subjecting the external terminal 41 to, for example, insert molding in the accommodating body 22. More specifically, the external terminal 41 is disposed in such a manner as to penetrate the accommodating body 22 in the positive Z-axis direction from an inside of the accommodating body 22 at the corner part of the accommodating body 22, projecting into a recess part that is formed at the corner part of the accommodating body 22. The external terminal 41 is electrically connected to the connection part 24 via the control device 21 with an electric wire (a power supply line) or the like (not illustrated) in the accommodating body 22. Thus, the external terminal 41 is electrically connected to the connection part 911 via the connection part 24 and the bus bar 30.

The external terminal 42 is a negative external terminal (a negative module terminal (a battery terminal)) being an external terminal of the negative electrode that is electrically connected to a negative electrode terminal of an energy storage device 400 included in the energy storage unit 10. The external terminal 42 is disposed at an end part of the energy storage unit 10 in the negative X-axis direction and the positive Y-axis direction. Specifically, the external terminal 42 is disposed projecting in the positive Z-axis direction from a corner part of the second outer case 120 in the negative X-axis direction and the positive Y-axis direction by subjecting the external terminal 42 to, for example, insert molding in the second outer case 120. More specifically, the external terminal 42 is disposed in such a manner as to penetrate the second outer case 120 in the positive Z-axis direction from an inside of the second outer case 120 at the corner part of the second outer case 120, projecting into a recess part that is formed at the corner part of the second outer case 120. The external terminal 42 is connected to the connection part 921 inside the second outer case 120.

As seen from the above, at least one of the external terminals 40, the positive external terminal and the negative external terminal, is disposed in the control unit 20. In the present embodiment, the external terminal 41 as the positive external terminal is disposed in the control unit 20, and the external terminal 42 as the negative external terminal is disposed in the energy storage unit 10. Via these external terminals 41 and 42, the energy storage apparatus 1 is charged by external electricity or discharges electricity to the outside. The external terminals 41 and 42 are formed of metallic conductive members made of aluminum, aluminum alloy, copper, copper alloy, or the like.

### 2 Description of Configuration of Energy Storage Device 400

Next, a configuration of an energy storage device 400 will be described in more detail. The eight energy storage devices 400 (the two first energy storage devices 401, two second energy storage devices 402, two third energy storage devices 403, and two fourth energy storage devices 404) included in the energy storage unit 10 all have the same configuration. Thus, a configuration of one of the energy storage devices 400 will be described below.

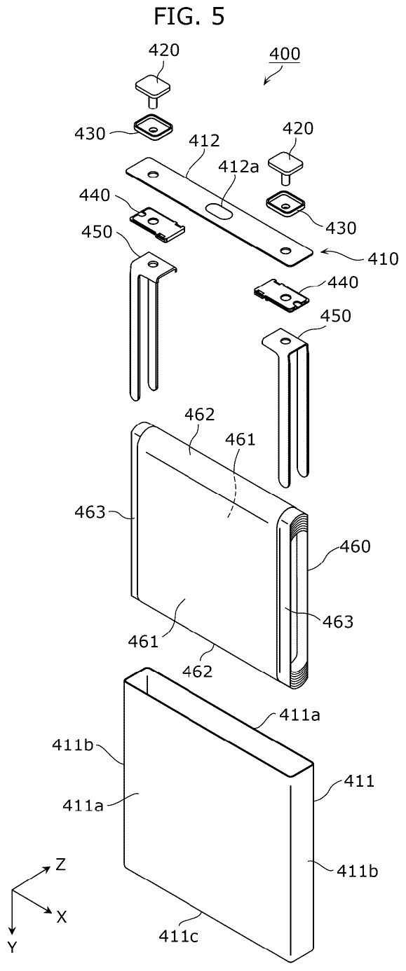

FIG. 5 is an exploded perspective view illustrating constituent components of an energy storage device 400 according to the present embodiment in a disassembled manner. Specifically, FIG. 5 illustrates disassembled components of the energy storage device 400 illustrated in FIG. 4 being vertically placed (standing).

As illustrated in FIG. 5, the energy storage device 400 includes a container 410, a pair of (positive and negative) electrode terminals 420, and a pair of (positive and negative) gaskets 430. The container 410 accommodates, inside the container 410, a pair of (positive and negative) gaskets 440, a pair of (positive and negative) current collectors 450, and the electrode body 460. Inside the container 410, an electrolyte (a non-aqueous electrolyte) is enclosed. Illustration of the electrolyte is omitted. As the electrolyte, any type of electrolyte can be used as long as the type of electrolyte does not impair performance of the energy storage device 400, and various types of electrolytes can be selected. In addition to the constituent components, a spacer that is disposed on a lateral side, a lower side, or the like of the electrode body 460, an insulation film that wraps around the electrode body 460, an insulation sheet that covers an outer surface of the container 410, or the like may be disposed.

The container 410 is a case in a rectangular-parallelepiped shape (a square shape or a box shape) that includes a container body 411 formed with an opening and includes a container lid 412 closing the opening of the container body 411. With such a configuration, the container 410 has a structure that enables an inside thereof to be closely sealed by welding the container body 411 and the container lid 412 after the electrode assembly 460 and the like is accommodated inside the container body 411. Materials of the container body 411 and the container lid 412 are not particularly limited. The materials are each preferably a weldable metal such as stainless steel, aluminum, aluminum alloy, iron, or a plated steel sheet.

The container body 411 is a member in a rectangular, tubular shape that is bottomed and constitutes a body of the container 410. The container body 411 is formed with the opening on a negative Y-axis direction side. The container body 411 includes a pair of wider lateral surfaces 411a in a rectangular, planar shape (flat) on lateral surfaces on both sides of the container body 411 in the Z-axis direction, includes a pair of narrower lateral surfaces 411b in a rectangular, planar shape (flat) on lateral surfaces on both sides of the container body 411 in the X-axis direction, and includes a bottom surface 411c in a rectangular, planar shape (flat) on a side of the container body 411 in the positive Y-axis direction. The container lid 412 is a plate-shaped member in a rectangular shape that constitutes a lid of the container 410. The container lid 412 is disposed on a side of the container body 411 in the negative Y-axis direction, extending in the X-axis direction. The container lid 412 is provided with a gas discharge valve 412a that releases pressure inside the container 410 when the pressure rises, an injection part (not illustrated) for injecting the electrolyte into an inside of the container 410, and the like. As seen from the above, the container 410 includes the container body 411 and the container lid 412 that are disposed being arranged in the Y-axis direction (the second direction) and are joined to each other. As mentioned above, the first energy storage devices 401 to the fourth energy storage devices 404 are disposed being arranged in the X-axis direction (the third direction), which is a longitudinal direction of the container lid 412.

The electrode assembly 460 is an energy storage constituent element (an energy generation element) that is formed by stacking a positive electrode sheet, a negative electrode sheet, and separators. The positive electrode sheet is made by forming a cathode active material layer on a cathode substrate layer, which is a current collector foil made of a metal such as aluminum or aluminum alloy. The negative electrode sheet is made by forming an anode active material layer on an anode substrate layer, which is a current collector foil made of a metal such as copper or copper alloy. As the active materials used as the cathode active material layer and the anode active material layer, known materials capable of occluding or releasing lithium ion can be used as appropriate. In the present embodiment, the electrode body 460 is a winding-type (what is called a vertically-winding-type) electrode body, which is formed by winding the electrode sheets (the positive electrode sheet and the negative electrode sheet) around a winding axis extending in the X-axis direction (an imaginary axis parallel to the X-axis direction).

The electrode sheets (the positive electrode sheet and the negative electrode sheet) of the electrode assembly 460 are stacked in the Z-axis direction, and therefore the Z-axis direction will be also called a stacking direction. The electrode assembly 460 is formed by stacking the electrode sheets in the stacking direction. As the electrode sheets are wound, the electrode body 460 includes a pair of flat parts 461 arranged in the Z-axis direction and a pair of curved parts 462 arranged in the Y-axis direction. The stacking direction is a direction of stacking the electrode sheets at the flat parts 461. The flat parts 461 are flat parts that couple end parts of the pair of curved parts 462. The curved parts 462 are parts that are curved in a semicircular shape or the like in such a manner as to project in the Y-axis direction. A direction in which flat surfaces of the flat parts 461 face or a direction in which the pair of flat parts 461 are opposite to each other can be defined as the stacking direction. Therefore, a plurality of first energy storage devices 401 can be considered to be arranged in the stacking direction. The same holds true for the other energy storage devices 400. The X-axis direction, in which the first energy storage devices 401 to the fourth energy storage devices 404 are arrayed, will be also called an arraying direction. The first energy storage devices 401 to the fourth energy storage devices 404 are arrayed in the arraying direction, which intersects the stacking direction.

In the electrode assembly 460, the positive electrode sheet and the negative electrode sheet are wound being shifted from each other in the X-axis direction. Thus, the positive electrode sheet and the negative electrode sheet include, at their end parts on sides in their shifted directions, parts on which the active materials are not formed (applied) and their substrate layers are exposed (active-material-layer unformed parts). The electrode body 460 includes, at both end parts of the electrode body 460 in the X-axis direction, end parts 463 that project from the flat parts 461 and the curved parts 462 on both sides of the electrode body 460 in the X-axis direction and at which the active-material-layer unformed parts of the positive electrode sheet and the negative electrode sheet are stacked and connected to the current collectors 450.

The electrode body 460 may be an electrode body of any form, such as what is called a horizontally-winding-type electrode body, which is formed by winding electrode sheets around a winding axis extending in the Y-axis direction, a stacked-type (stacked-type) electrode body, which is formed by stacking a plurality of electrode sheets in a tabular shape, or a bellows-type electrode body, in which electrode sheets are folded in bellows shape. In a case of the horizontally-winding-type electrode body, its parts being flat, other than curved parts and connection parts (tabs) to current collectors are flat parts. In a case of the stacked-type (stacked-type) or the bellows-type electrode body, its parts being flat, other than connection parts (tabs) to current collectors are flat parts.

The electrode terminals 420 are terminals (a positive electrode terminal and a negative electrode terminal) of the energy storage device 400. The electrode terminals 420 are disposed on the container lid 412 in such a manner as to project in the negative Y-axis direction. The electrode terminals 420 are electrically connected to the positive electrode sheet and the negative electrode sheet of the electrode body 460 via the current collectors 450. The electrode terminals 420 are formed of a conductive member made of a metal or the like such as aluminum, aluminum alloy, copper, or copper alloy.

The current collectors 450 are conductive members (a positive electrode current collector and a negative electrode current collector) that are electrically connected to the electrode terminals 420 and the end parts 463 of the electrode assembly 460. The current collectors 450 are formed of aluminum, aluminum alloy, copper, copper alloy, or the like. The gaskets 430 and 440 are sealing members in a tabular shape that are electrically insulative and are disposed between the container lid 412, and the electrode terminals 420 and the current collectors 450. The gaskets 430 and 440 are formed of any one of the electrically insulative resin materials or the like that can be used for the second outer case 120.

### 3 Description of Configuration Enabling Control Unit 20 to Be Removably Attached to Energy Storage Unit 10

Next, the configuration that enables the control unit 20 to be removably attached to the energy storage unit 10 will be described in more detail. FIG. 6 is a perspective view and a front view illustrating a configuration of a part of the energy storage unit 10 according to the present embodiment to which the control unit 20 is removably attached. Specifically, (a) in FIG. 6 is a perspective view illustrating the outer case end part 122, which is an end part of the energy storage unit 10 illustrated in FIG. 2 in the positive X-axis direction, in an enlarged manner. (b) in FIG. 6 is a front view illustrating a configuration of guide parts 124 and regulating parts 125 provided on the outer case end part 122 in (a) in FIG. 6 as viewed from the positive X-axis direction, in an enlarged manner.

FIG. 7 is a perspective view and a rear view illustrating a configuration of the control unit 20 according to the present embodiment. Specifically, (a) in FIG. 7 is a perspective view illustrating the configuration of the control unit 20 illustrated in FIG. 2 as viewed from below. (b) in FIG. 7 is a rear view illustrating a configuration of a projecting part 25 provided on the control unit 20 in (a) in FIG. 7 as viewed from the negative X-axis direction, in an enlarged manner. (b) in FIG. 7 illustrates a positional relation between the projecting part 25 and the outer case end part 122 in a case where the control unit 20 is attached to the energy storage unit 10, with the configuration in (b) in FIG. 6 superimposed in dashed lines.

As illustrated in FIG. 6, the second outer case 120 of the outer case 100 of the energy storage unit 10 includes, in addition to the configuration mentioned above, the guide parts 124, the regulating parts 125, a projection 126, and fixation parts 127. As illustrated in FIG. 7, the control unit 20 includes, in addition to the configuration mentioned above, projecting parts 25, a groove part 26, and fixing parts 27.

First, a configuration of the second outer case 120 will be described in detail. The guide parts 124 are recess parts (groove parts) that are surfaces of the outer case end part 122 on a side in the positive Z-axis direction recessed in the negative Z-axis direction. The guide parts 124 are groove parts that are disposed extending in the X-axis direction from one edge to the other edge of the outer case end part 122 in the X-axis direction and each of which has a width in the Y-axis direction gradually decreasing as the groove part extends in the negative X-axis direction from its edge in the positive X-axis direction. In the present embodiment, two guide parts 124 are formed at both end parts of the outer case end part 122 in the Y-axis direction. On inner sides of the guide parts 124, the projecting parts 25 of the control unit 20 are disposed. The guide parts 124 are formed such that the projecting parts 25 are slidable in the X-axis direction. The guide parts 124 function as parts that are formed such that the control unit 20 is slidable along the guide parts 124, and that guide movement of the control unit 20.

The regulating parts 125 are parts in a plate shape that project, at an end part of each guide part 124 in the negative X-axis direction, in the Y-axis direction from end parts of the guide part 124 in the positive Z-axis direction inward of the guide part 124 and extend in the X- axis direction. In each guide part 124, a pair of regulating parts 125 that project inward in the Y-axis direction from both sides of the guide part 124 in the Y-axis direction and are opposite to each other in the Y-axis direction are disposed. The regulating parts 125 function as parts that regulate the movement of the control unit 20 in directions (the Y-axis direction, the Z-axis direction) that intersect a sliding direction of the control unit 20 (the X-axis direction) by restricting movement of the projecting parts 25 of the control unit 20 in the positive Z-axis direction and/or the Y-axis direction.

The projection 126 is a part in a columnar shape that is a surface at a center part in the X-axis direction and a center part in the Y-axis direction of the outer case end part 122 on a side of the outer case end part 122 in the positive Z-axis direction projecting in the positive Z-axis direction. The projection 126 is disposed inside the groove part 26 of the control unit 20 and is formed being slidable along the groove part 26 in the X-axis direction.

The fixation parts 127 are recess parts that are formed at an end part of the outer case end part 122 in the positive X-axis direction and the negative Y-axis direction and at an end part of the outer case end part 122 in the negative X-axis direction and the positive Y-axis direction. To the fixation parts 127, the fixing parts 27 of the control unit 20 are inserted and fixed. Specifically, the fixation parts 127 include internal thread parts formed with internal threads. By fastening and securing external thread parts of the fixing parts 27 to the internal thread parts, the control unit 20 is fixed to the outer case end part 122.

Next, the configuration of the control unit 20 will be described in detail. The projecting parts 25 are parts in a projecting shape that project in the negative Z-axis direction from a surface of the accommodating body 22 on a side of the accommodating body 22 in the negative Z-axis direction. Two projecting parts 25 are disposed at both end parts of the accommodating body 22 in the Y-axis direction at an end part of the accommodating body 22 in the negative X-axis direction, corresponding to the two guide parts 124 of the second outer case 120. The projecting parts 25 each include a first projecting part 25a and a second projecting part 25b.

The first projecting part 25a is a part in a columnar shape that extends in the negative Z-axis direction from the surface of the accommodating body 22 on the side of the accommodating body 22 in the negative Z-axis direction. The second projecting part 25b is a part in a disk shape that is disposed on a side of the first projecting part 25a in the negative Z-axis direction and has a width in the Y-axis direction larger than the first projecting part 25a. The second projecting part 25b is disposed projecting from the first projecting part 25a toward both sides of the first projecting part 25a in the Y-axis direction. In the Y-axis direction, widths of the first projecting part 25a and the second projecting part 25b are smaller than a width of each guide part 124 of the second outer case 120. In the Y-axis direction, the width of the first projecting part 25a is smaller than a distance between the pair of regulating parts 125 disposed at each guide part 124, and the width of the second projecting part 25b is larger than the distance between the pair of regulating parts 125.

The groove part 26 is a recess part (a groove part) that is a surface of the accommodating body 22 on the side of the accommodating body 22 in the negative Z-axis direction recessed in the positive Z-axis direction. The groove part 26 is disposed extending from an edge of the accommodating body 22 on a side of the accommodating body 22 in the negative X-axis direction to a center part of the accommodating body 22 in the X-axis direction at a center part of the accommodating body 22 in the Y-axis direction. The groove part 26 is a groove part that has a width in the Y-axis direction gradually decreasing as the groove part extends in the positive X-axis direction from its edge in the negative X-axis direction. The groove part 26 is formed such that the width of the groove part 26 in the Y-axis direction is larger than a width of the projection 126 in the Y-axis direction across the groove part 26 in the X-axis direction. The groove part 26 is formed such that the projection 126 is disposed inside the groove part 26 and is slidable in the X-axis direction. The groove part 26 functions as a part that guides movement of the control unit 20 with respect to the energy storage unit 10.

The fixing parts 27 are bolts that penetrate the accommodating body 22 in the Z-axis direction. The external thread parts of the fixing parts 27 are disposed projecting from the accommodating body 22 in the negative Z-axis direction. The fixing parts 27 are disposed at positions at an end part of the accommodating body 22 in the positive X-axis direction and the negative Y-axis direction and at an end part of the accommodating body 22 in the negative X-axis direction and the positive Y-axis direction that correspond to the fixation parts 127. The fixing parts 27 are secured and fixed to the fixation parts 127 by fastening the external thread parts to the respective internal thread parts of the fixation parts 127. The fixing parts 27 and the fixation parts 127 may be fixed together by means other than bolt securing. The fixing parts 27 and the fixation parts 127 may be fixed by means such as engaging or fitting with, for example, recess parts being formed on ones of the fixing parts 27 and the fixation parts 127 and protrusion parts being formed on the others.

With such a configuration, when the control unit 20 is attached to the outer case end part 122, the two projecting parts 25 of the control unit 20 are slid from the positive X-axis direction to the negative X-axis direction along the two guide parts 124 of the outer case end part 122. At this time, the projection 126 of the outer case end part 122 is slid from the negative X-axis direction to the positive X-axis direction along the groove part 26 of the control unit 20. As seen from the above, the control unit 20 is configured to be slidable with respect to the outer case end part 122.

In the projecting parts 25, the second projecting parts 25b are further slid along the guide parts 124 in the negative X-axis direction to be disposed in the regulating parts 125 on sides of the regulating parts 125 in the negative Z-axis direction. Thus, movement of the second projecting part 25b in the positive Z-axis direction is regulated by the regulating parts 125, and movement of the control unit 20 with respect to the outer case end part 122 in the Z-axis direction (a direction intersecting the sliding direction of the control unit 20) is regulated.

By fixing the fixing parts 27 of the control unit 20 to the fixation parts 127 of the outer case end part 122, the control unit 20 is fixed to the outer case end part 122 of the energy storage unit 10. The bus bar 30 is connected to the connection part 911 of the energy storage unit 10 and the connection part 24 of the control unit 20. In this manner, the control unit 20 is attached to the energy storage unit 10. The control unit 20 can be detached from the energy storage unit 10 by performing an operation of attaching the control unit 20 to the energy storage unit 10 in reversed order.

### 4 Description of Advantageous Effects

As described above, in the energy storage apparatus 1 according to the embodiment of the present invention, the control unit 20 includes the control device 21 that is connected to the main current path of the energy storage devices 400 and controls the energy storage devices 400, and is removably attached to the outer case 100 of the energy storage unit 10 in a state of being in contact with the outer case 100. As seen from the above, by configuring the control unit 20 including the control device 21 to be removably attached to the outer case 100, it is possible to attach and detach the control unit 20 to and from the energy storage unit 10 in a case where a malfunction occurs in the control device 21, a case where a design of the control device 21 is to be changed, or the like. Thus, the control device 21 can be attached to and detached from the energy storage unit 10, and thus it is possible to easily perform a maintenance operation, a replacement operation, or the like of the control device 21. Since the control unit 20 is attached to the outer case 100 of the energy storage unit 10 in a state of being in contact with the outer case 100, it is possible to prevent an increase in size of the energy storage apparatus 1 even when the control unit 20 is configured to be removable.

Since the energy storage apparatus 1 includes the bus bar 30, which is a connection member that is removably connected to the connection part 911 of the energy storage unit 10 and the connection part 24 of the control unit 20, the control unit 20 can be easily attached to and detached from the energy storage unit 10 by attaching and detaching the bus bar 30. Thus, it is possible to easily perform the maintenance operation, the replacement operation, or the like of the control device 21 included in the control unit 20.

Since the external terminal 41, which is at least one of the positive external terminal and the negative external terminal of the energy storage apparatus 1 (the positive external terminal in the present embodiment) is disposed in the control unit 20, it is possible to dispose the external terminal 41 close to the control device 21. Thus, it is possible to shorten a length of a conductive member coupling the external terminal 41 and the control device 21 together, such as a wire or a bus bar. By shortening the length of the conductive member, it is possible to reduce a resistance against the main current flowing, reduce a space to dispose the conductive member, and reduce costs.

Since the external terminal 41 can be attached to and detached from the energy storage unit 10 together with control unit 20, it is possible to easily perform a maintenance operation, a replacement operation, or the like of the external terminal 41. By performing the replacement operation of the external terminal 41, it is possible to perform changing a size and a shape of the external terminal 41 (sizes, shapes, etc., of an external thread portion, an internal thread portion, and other portions), changing a position of disposing the external terminal 41, and the like. As seen from the above, by changing the control unit 20, it is possible to perform the changes on the external terminal 41 without changing a shape of another component such as the outer case 100. Thus, diversification of a model at a minimum change cost is expected.

Since the outer case 100 of the energy storage unit 10 includes the guide parts 124 along which the control unit 20 is slidable, the control unit 20 can be slid to move with respect to the outer case 100. Thus, the control unit 20 can be easily attached to and detached from the energy storage unit 10, and thus it is possible to easily perform the maintenance operation, the replacement operation, or the like of the control device 21 included in the control unit 20.

Since the outer case 100 of the energy storage unit 10 includes the regulating parts 125, the movement of the control unit 20 in the direction intersecting the sliding direction is regulated after the control unit 20 is slid and attached to the energy storage unit 10. Thus, it is possible to easily prevent the control unit 20 from coming off from the energy storage unit 10 when the control unit 20 is attached to the energy storage unit 10, and thus it is possible to easily perform an operation of attaching the control unit 20 to the energy storage unit 10.

### 5. Other Variations

Although energy storage apparatus 1 according to the present invention has been described based on the above embodiment, the present invention is not limited to the embodiment. The disclosed embodiment is merely exemplary and do not limit the present invention. The scope of the present invention is indicated not by the above description but by the appended claims. Accordingly, all modifications are intended to be included within the same meanings and the scope of the claims.

In the above embodiment, it is assumed that, in the outer case 100, the second outer case 120 is a member in a bottomed, rectangular, tubular shape that is formed with the opening on its negative Z-axis direction side, and the first outer case 110 is a member in a flat, rectangular shape that closes the opening of the second outer case 120. The first outer case 110 may be a member in a bottomed, rectangular, tubular shape that is formed with an opening on its positive Z-axis direction side, and the second outer case 120 may be a lid in a flat, rectangular shape that closes the opening of the first outer case 110. Alternatively, the first outer case 110 and the second outer case 120 may have any shapes. In this case also, the outer case 100 is only required to have a configuration in which the control unit 20 is removably attached to the outer case 100.

In the above embodiment, it is assumed that the first outer case 110 is disposed on sides of the energy storage devices 400 in the negative Z-axis direction, the restraining bodies 600 are disposed on sides of the energy storage devices 400 in the positive Z-axis direction, and the first outer case 110 and the restraining bodies 600 are joined together. The first outer case 110 may be disposed on the sides of the energy storage devices 400 in the positive Z-axis direction, the restraining bodies 600 may be disposed on the sides of the energy storage devices 400 in the negative Z-axis direction, and the first outer case 110 and the restraining bodies 600 may be joined together. The configuration of the energy storage apparatus 1 may be inverted upside down.

In the above embodiment, it is assumed that the restraining bodies 600 are attached to the first outer case 110 to restrain the energy storage devices 400. The restraining bodies 600 may be attached to another member to restrain the energy storage devices 400, rather than being attached to the first outer case 110.

In the above embodiment, it is assumed that the control unit 20 is removably attached to the outer case end part 122 of the second outer case 120 of the outer case 100. The control unit 20 may be attached to any position of the outer case 100 as long as the control unit 20 has a configuration in which the control unit 20 is removably attached to the outer case 100. The control unit 20 may be attached to a position of the second outer case 120 other than an end part of the second outer case 120. The control unit 20 may be attached to the first outer case 110 rather than the second outer case 120.

In the above embodiment, it is assumed that the control unit 20 is removably attached to the energy storage unit 10 by the bus bar 30 being removably connected to the connection part 911 of the energy storage unit 10 and the connection part 24 of the control unit 20. The configuration in which the control unit 20 is removably attached to the energy storage unit 10 is not particularly limited and may be any configuration. One of the control unit 20 and the energy storage unit 10 may include a conductive projecting part such as a power plug, and the control unit 20 may be removably attached to the energy storage unit 10 by inserting the projecting part into a recess part of the other. In this case, the number and shapes of projecting parts and recess parts are not particularly limited. This dispenses with need of providing the bus bar 30, and thus the number of components can be reduced.

In the above embodiment, it is assumed that the second outer case 120 of the outer case 100 includes the guide parts 124 and the regulating parts 125. The outer case 100 need not include the guide parts 124 and need not include the regulating parts 125. One of the outer case 100 and the control unit 20 may include a positioning pin, the other may include a recess part into which the positioning pin is inserted, and the control unit 20 may be positioned without being slid with respect to and fixed to the outer case 100.

In the above embodiment, it is assumed that the external terminal 41 as the positive external terminal is disposed in the control unit 20, and the external terminal 42 as the negative external terminal is disposed in the energy storage unit 10. It is only required that at least one of the external terminals 40, the positive external terminal and the negative external terminal, is disposed in the control unit 20. The external terminal 41 as the positive external terminal may be disposed in the energy storage unit 10, and the external terminal 42 as the negative external terminal may be disposed in the control unit 20. In a case where the external terminal is disposed in the energy storage unit 10, the outer case 100 may be used as the external terminal disposed in the energy storage unit 10. In the above embodiment, the first outer case 110 may be used as the negative external terminal instead of the external terminal 42 by decreasing a potential of the first outer case 110 to a potential of the negative electrode.

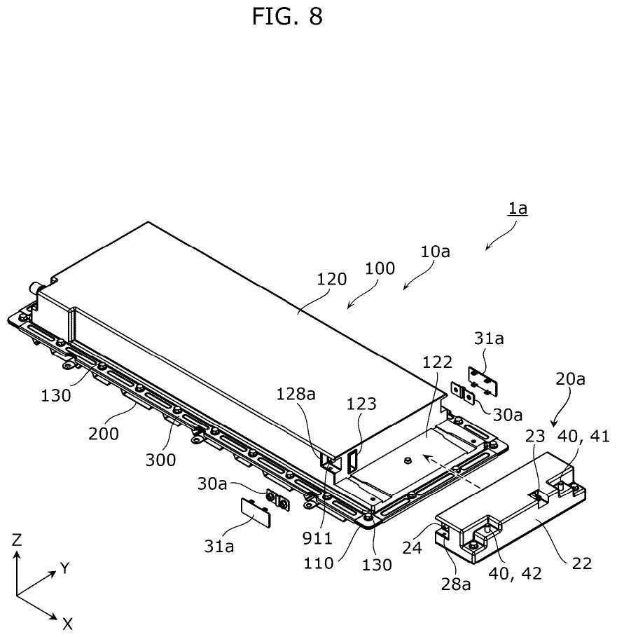

Both of the external terminal 41 as the positive external terminal and the external terminal 42 as the negative external terminal may be disposed on the control unit 20. FIG. 8 is a perspective view illustrating a configuration of an energy storage apparatus 1a according to a variation of the present embodiment, with an energy storage unit 10a and a control unit 20a being separated from each other. FIG. 8 is a diagram corresponding to FIG. 2 without illustration of the control device 21.

As illustrated in FIG. 8, in the present variation, the energy storage apparatus 1a is disposed instead of the energy storage apparatus 1 in the above embodiment. The energy storage apparatus 1a includes the energy storage unit 10a and the control unit 20a. No external terminal is disposed in the energy storage unit 10a, and the pair (positive and negative) of external terminals 40 (41 and 42) are disposed in the control unit 20a. The external terminal 42 disposed in the energy storage unit 10 in the above embodiment is disposed in the control unit 20a in the present variation. In other words, in the present variation, both of the external terminals 40, the positive external terminal and the negative external terminal, are disposed in the control unit 20a.

With such a configuration, the energy storage unit 10a includes a pair (positive and negative) of connection parts 911 on both sides of the second outer case 120 in the Y-axis direction, and the control unit 20a includes a pair (positive and negative) of connection parts 24 on both sides of the accommodating body 22 in the Y-axis direction. The pair of connection parts 911 and the pair of connection parts 24 are disposed inside a pair of recess parts 128a and a pair of recess parts 28a, respectively, and connected to each other with a pair (positive and negative) of bus bars 30a, and the pair of recess parts 128a and the pair of recess parts 28a are closed by a pair of cover members 31a.

In the present variation, the connection parts 911 and the respective connection parts 24 are disposed being arranged in the X-axis direction, and disposed inside the recess parts 128a and the recess parts 28a arranged in the X-axis direction, respectively, and are connected together by the bus bars 30a extending in the X-axis direction. The recess parts 128a and the respective recess parts 28a arranged in the X-axis direction are closed by the cover members 31a extending in the X-axis direction. The connection parts 911 and the respective connection parts 24 may be arranged in the Z-axis direction as in the above embodiment. The rest of the configuration of the present variation is the same as that of the above embodiment and thus will not be described in detail.

As seen from the above, the present variation can provide the same advantageous effects as in the above embodiment. In particular, in the present variation, since both of the positive external terminal and the negative external terminal of the energy storage apparatus 1a are disposed in the control unit 20a, it is possible to dispose both of the positive external terminal and the negative external terminal close to the control device 21. Thus, a component of the control device 21 that is preferably disposed close to the positive external terminal (a relay, etc.) can be disposed close to the positive external terminal, and a component of the control device 21 that is preferably disposed close to the negative external terminal (a shunt resistance, etc.) can be disposed close to the negative external terminal. Since both of the positive external terminal and the negative external terminal can be attached to and detached from the energy storage unit 10a together with the control unit 20a, it is possible to easily perform a maintenance operation, a replacement operation, or the like of both of the positive external terminal and the negative external terminal.

Although the control unit includes the control device 21 that is connected to the main current path of the energy storage devices 400 and controls the energy storage devices 400, both of the positive external terminal and the negative external terminal need not be disposed in the control unit. Both of the positive external terminal and the negative external terminal may be disposed in the energy storage unit. In this case also, by configuring the control unit to be attachable to or detachable from the energy storage unit, it is possible to easily perform a maintenance operation, a replacement operation, or the like of the control device 21.

The energy storage apparatus need not include all of the constituent components mentioned above. The energy storage apparatus need not include the first reinforcement member 200, the second reinforcement members 300, the spacers 500, the restraining bodies 600, or the like.

It should be noted that embodiments arrived at by selectively combining elements disclosed in the above embodiment and variations may be included within the scope of the present invention.

The present invention may be implemented as not only an energy storage apparatus but also a combination of an outer case of an energy storage unit and a control unit.

### INDUSTRIAL APPLICABILITY

The present invention is applicable to an energy storage apparatus that includes an energy storage device such as a lithium-ion secondary battery.

### REFERENCE SIGNS LIST

1, 1a energy storage apparatus
10 10a energy storage unit
20, 20a control unit
21 control device
22 accommodating body
23, 123 connector
24, 911, 921, 922 connection part
25 projecting part
25a first projecting part
25b second projecting part
26 groove part
27 fixing part
28, 28a, 128, 128a recess part
30, 30a, 800, 810, 820, 830 bus bar
31, 31a cover member
40, 41, 42 external terminal
100 outer case
110 first outer case
120 second outer case
122 outer case end part
124 guide part
125 regulating part
126, 521 projection
127 fixation part
130 fixing member
400 energy storage device
410 container
420 electrode terminal
450 current collector
460 electrode body
500 spacer
600 restraining body
700 bus bar frame
900, 910, 920 conductive member

1. An energy storage apparatus comprising:
an energy storage unit including an energy storage device and an outer case accommodating the energy storage device; and
a control unit including a control device that is connected to a main current path of the energy storage device and controls the energy storage device, wherein
the control unit is removably attached to the outer case in a state of being in contact with the outer case.

2. The energy storage apparatus according to claim 1, further comprising:
a connection member disposed on the main current path of the energy storage device, and removably connected to a connection part of the energy storage unit and a connection part of the control unit.

3. The energy storage apparatus according to claim 1, further comprising:
a positive external terminal that is an external terminal of a positive electrode; and
a negative external terminal that is an external terminal of a negative electrode, wherein
at least one of the positive external terminal or the negative external terminal is provided to the control unit.

4. The energy storage apparatus according to claim 3, wherein
both of the positive external terminal and the negative external terminal are provided to the control unit.

5. The energy storage apparatus according to claim 1, wherein
the outer case includes a guide part along which the control unit is slidable.

6. The energy storage apparatus according to claim 5, wherein
the outer case further includes a regulating part that regulates movement of the control unit in a direction intersecting a sliding direction of the control unit.
